(19) United States
(12) Patent Application Publication
(10) Pub. No.: US 2026/0140371 A1
(43) Pub. Date: May 21, 2026

(54) IMAGE LIGHT GUIDE SYSTEM WITH ALIGNED BLOCKING FEATURES

(71) Applicant: Vuzix Corporation, West Henrietta, NY (US)

(72) Inventors: Robert J. Schultz, Victor, NY (US); Marek W. Kowarz, Henrietta, NY (US)

(21) Appl. No.: 19/117,069

(22) PCT Filed: Sep. 29, 2023
(86) PCT No.: PCT/US2023/034187

§ 371 Date: Mar. 30, 2025

Related U.S. Application Data
(60) Provisional application No. 63/412,314, filed on Sep. 30, 2022.

(51) Int. Cl. G02B 27/01; G02B 5/00; G02B 5/18; G02B 5/30; G02B 27/00

(52) U.S. Cl. CPC G02B 27/0101; G02B 5/003; G02B 5/1823; G02B 5/1842; G02B 5/3025; G02B 27/0081

(57) ABSTRACT

An image light guide system including an image light guide having an out-coupling diffractive region. The out-coupling diffractive region includes one or more sub-regions having diffractive features arranged to diffract at least a first portion of image-bearing light toward an eyebox. The image light guide system also includes a blocking region having a plurality of blocking features arranged to prevent a second portion of image-bearing light reflected from the one or more sub-regions from exiting the image light guide system in a direction opposite the eyebox. In son examples the blocking region is disposed on a surface of the image light guide, on a surface of a low-index cladding layer, or on a surface of a support substrate positioned a distance from the image light guide.

### TECHNICAL FIELD

The present disclosure generally relates to electronic displays, and more particularly, to displays utilizing image light guides with diffractive optics to convey image-bearing light to a viewer.

### BACKGROUND

Head-Mounted Displays (HMDs) are being developed for a range of diverse uses, including military, commercial, industrial, firefighting, and entertainment applications. For many of these applications, there is particular value in forming a virtual color image that can be visually superimposed over the real-world image that lies in the field of view of the HMD user. Optically transparent flat parallel plate waveguides, also called planar waveguides, convey image-bearing light generated by a color projector system to the HMD user. The planar waveguides convey the image-bearing light in a narrow space to direct the virtual image to the HMD user's pupil and enable the superposition of the virtual image over the real-world image that lies in the field of view of the HMD user.

In such conventional imaging light guides, collimated, relatively angularly encoded light beams from a polychromatic or monochromatic image projector source are coupled into an optically transparent planar waveguide by an input coupling optic, such as an in-coupling diffractive optic, which can be mounted or formed on a surface of the parallel plate planar waveguide or disposed within the waveguide. Such diffractive optics can be formed as diffraction gratings, holographic optical elements, or in other known ways. For example, the diffraction grating can be formed as a surface relief grating. After propagating along the planar waveguide, the diffracted color image-bearing light can be directed back out of the planar waveguide by a similar output grating, which may be arranged to provide pupil expansion along one or more dimensions of the virtual image. In addition, one or more diffractive turning gratings may be positioned along the waveguide optically between the input and output gratings to provide pupil expansion in one or more dimensions of the virtual image. The image-bearing light output from the parallel plate planar waveguide provides an expanded eyebox for the viewer.

A HMD system may consist of at least one transparent image conveying waveguide for conveying virtual image-encoded light to the left eye of the viewer and at least one image conveying waveguide for conveying virtual image-encoded light to the right eye of the viewer, thus enabling stereo images to the viewer.

Diffraction gratings may be visible by an outside observer of the HMD system. When environmental light or light generated by the HMD system diffracts upon engagement with the diffractive gratings, light is scattered in multiple directions, some visible by an outside observer. An HMD system with a large continuous out-coupling area is therefore aesthetically undesirable as an outside observer will be able to see the diffractive pattern on the transparent waveguide.

Additionally, certain applications of such a transparent waveguide may allow portions of light used to generate a virtual image to “leak” out of the front of the waveguide, e.g., in the direction the wearer is facing while wearing the HMD system. This forward-leaking light can compromise the security of the image or information being displayed to the wearer as others in the vicinity will be able to see the light emitted from the system. The forward-leaking light also represents an inefficiency in the formation of virtual images using the HMD system in that light that leaks out of the front of the waveguide is not used to form a virtual image within the wearer's eyes, and thus the virtual images presented may appear less bright than they would otherwise appear.

### SUMMARY

The present disclosure is directed to one or more exemplary embodiments of an image light guide system including an image light guide having a diffractive out-coupling region. The diffractive out-coupling region includes one or more diffractive sub-regions having diffractive features arranged to diffract at least a first portion of light coupled within the image light guide toward an eyebox. The image light guide system also includes a blocking region having a plurality of blocking features arranged to prevent a second portion of light reflected from the one or more diffractive sub-regions from exiting the image light guide system in a direction opposite the eyebox. In some examples the blocking region is disposed on a surface of the image light guide, on a surface of a low-index cladding layer, or on a surface of a support substrate positioned a distance from the image light guide. In some examples, the system can include more than one image light guide formed in a stack such that light reflected from the diffractive sub-regions of each image light guide within the stack is prevented from exiting the image light guide system in a direction opposite the eyebox. In an alternative configuration, the image light guide system may include a single diffractive sub-region that includes diffractive features and a plurality of open sub-regions.

In an exemplary embodiment, an image light guide system is provided. The image light guide system includes: an image light guide having an in-coupling diffractive optic operable to couple image-bearing light into the image light guide; and an out-coupling diffractive region comprising a plurality of out-coupling diffractive sub-regions, wherein each out-coupling diffractive sub-region of the plurality of out-coupling diffractive sub-regions comprises a plurality of diffractive features arranged to out-couple at least a first portion of the image-bearing light and direct the first portion of image-bearing light in a first direction toward an eyebox, and wherein the plurality of diffractive features are arranged to diffract at least a second portion of the image-bearing light in a second direction opposite the first direction. The image light guide system further includes a blocking region comprising a plurality of blocking features, wherein each blocking feature of the plurality of blocking features is aligned with a respective out-coupling diffractive sub-region of the plurality of out-coupling sub-regions, such that each blocking feature of the plurality of blocking features is operable to prevent the second portion of the image-bearing light from exiting the image light guide system in the second direction.

In another exemplary embodiment, an image light guide system is provided. The image light guide system includes an image light guide having: an in-coupling diffractive optic operable to couple image-bearing light into the image light guide; and an out-coupling diffractive region comprising a plurality of diffractive features arranged to out-couple at least a first portion of the image-bearing light and direct the first portion of image-bearing light in a first direction toward an eyebox, and wherein the plurality of diffractive features are arranged to diffract at least a second portion of the image-bearing light in a second direction opposite the first direction; and a first plurality of open sub-regions arranged within the out-coupling diffractive region. The image light guide system further includes a blocking region comprising a second plurality of open sub-regions, wherein each sub-region of the first plurality of open sub-regions is aligned with a respective sub-region of the second plurality of open sub-regions, such that the blocking region is operable to prevent the second portion of the image-bearing light from exiting the image light guide system in the second direction.

These and other aspects, objects, features, and advantages of the present disclosure will be more clearly understood and appreciated from the following detailed description of the embodiments and appended claims, and by reference to the accompanying drawing figures.

### BRIEF DESCRIPTION OF THE DRAWING FIGURES

The accompanying drawings are incorporated herein as part of the specification. The drawings described herein illustrate embodiments of the presently disclosed subject matter and are illustrative of selected principles and teachings of the present disclosure. However, the drawings do not illustrate all possible implementations of the presently disclosed subject matter and are not intended to limit the scope of the present disclosure in any way.

FIG. 1 is a top view of an image light guide with an exaggerated thickness for showing the propagation of light from an image source along the image light guide to an eyebox within which the virtual image can be viewed.

FIG. 2 is a perspective view of an image light guide including an in-coupling diffractive optic, a turning diffractive optic, and out-coupling diffractive optic for managing the propagation of image-bearing light beams.

FIG. 3 is a front perspective view of an image light guide according to an exemplary embodiment of the presently disclosed subject matter.

FIG. 4 is a side-elevational view of an image light guide system according to an exemplary embodiment of the presently disclosed subject matter.

FIG. 5 is a front-elevational view of a portion of the image light guide illustrated in FIG. 3 according to an exemplary embodiment of the presently disclosed subject matter.

FIG. 6 is a side-elevational view of a portion of the image light guide illustrated in FIG. 4 according to an exemplary embodiment of the presently disclosed subject matter.

FIG. 7 is a front-elevational view of a portion of the image light guide illustrated in FIG. 3 according to an exemplary embodiment of the presently disclosed subject matter.

FIG. 8 is a side-elevational view of an image light guide system according to an exemplary embodiment of the presently disclosed subject matter wherein the image light guide system includes a cladding layer.

FIG. 9 is a side-elevational view of an image light guide system according to an exemplary embodiment of the presently disclosed subject matter wherein the image light guide system includes a cladding layer.

FIG. 10 is a side-elevational view of an image light guide system according to an exemplary embodiment of the presently disclosed subject matter wherein the image light guide system includes a support substrate.

FIG. 11 is a side-elevational view of an image light guide system according to an exemplary embodiment of the presently disclosed subject matter wherein the image light guide system includes a support substrate.

FIG. 12 is a side-elevational view of an image light guide system according to an exemplary embodiment of the presently disclosed subject matter wherein the image light guide system includes a cladding layer and polarization filters.

FIG. 13 is a side-elevational view of an image light guide system according to an exemplary embodiment of the presently disclosed subject matter wherein the image light guide system includes two image light guides in a stacked arrangement.

FIG. 14 is a side-elevational view of an image light guide system according to an exemplary embodiment of the presently disclosed subject matter wherein the image light guide system includes two image light guides in a stacked arrangement.

FIG. 15A is a front-elevational view of a portion of the image light guide illustrated in FIG. 3 according to an exemplary embodiment of the presently disclosed subject matter where the diffractive region includes a single diffractive sub-region and a plurality of open sub-regions.

FIG. 15B is a rear-elevational view of a portion of the image light guide illustrated in FIG. 3 according to an exemplary embodiment of the presently disclosed subject matter where the blocking region includes a single blocking feature and a plurality of open sub-regions.

FIG. 16 is a front perspective view of an image light guide according to an exemplary embodiment of the presently disclosed subject matter.

### DETAILED DESCRIPTION

It is to be understood that the invention may assume various alternative orientations and step sequences, except where expressly specified to the contrary. It is also to be understood that the specific assemblies and systems illustrated in the attached drawings and described in the following specification are simply exemplary embodiments of the inventive concepts defined herein. Hence, specific dimensions, directions, or other physical characteristics relating to the embodiments disclosed are not to be considered as limiting, unless expressly stated otherwise. Also, although they may not be, like elements in various embodiments described herein may be commonly referred to with like reference numerals within this section of the application.

One skilled in the relevant art will recognize that the elements and techniques described herein can be practiced without one or more of the specific details, or with other methods, components, materials, etc. In some instances, well-known structures, materials, or operations are not shown or described in detail to avoid obscuring certain aspects of the present disclosure. Reference throughout the specification to “one embodiment” or “an embodiment” means that a particular feature, structure, or characteristic described in connection with the embodiment is included in at least one embodiment of the present disclosure. Thus, the appearance of the phrase “in one embodiment” or “in an embodiment” throughout the specification is not necessarily referring to the same embodiment. However, the particular features, structures, or characteristics described may be combined in any suitable manner in one or more embodiments.

Where used herein, the terms “first,” “second,” and so on, do not necessarily denote any ordinal, sequential, or priority relation, but are simply used to more clearly distinguish one element or set of elements from another, unless specified otherwise.

Where used herein, the terms “viewer,” “operator,” “observer,” and “user” are considered equivalents and refer to the person or machine who wears and/or views images using a device having an imaging light guide. Where used herein, the term “set” refers to a non-empty set, as the concept of a collection of elements or members of a set is widely understood in elementary mathematics. The term “subset,” unless otherwise explicitly stated, is used herein to refer to a non-empty proper subset, that is, to a subset of the larger set, having one or more members. For a set S, a subset may comprise the complete set S. A “proper subset” of set S, however, is strictly contained in set S and excludes at least one member of set S.

Where used herein, the terms “coupled,” “coupler.” or “coupling” in the context of optics refer to a connection by which light travels from one optical medium or device to another optical medium or device.

Where used herein, the term “beam expansion” is intended to mean replication of a beam via multiple encounters with an optical element to provide exit pupil expansion in one or more dimensions. Similarly, where used herein, the terms “expanded image-bearing light beams” and “expanded set of angularly related beams” refer to a light beam replicated via multiple encounters with an optical element to provide exit pupil expansion in one or more dimensions.

Where used herein, the term “about” when applied to a value is intended to mean within the tolerance range of the equipment used to produce the value, or, in some examples, is intended to mean plus or minus 10%, or plus or minus 5%, or plus or minus 1%, unless otherwise expressly specified.

Where used herein, the term “substantially” is intended to mean within the tolerance range of the equipment used to produce the value, or, in some examples, is intended to mean plus or minus 10%, or plus or minus 5%, or plus or minus 1%, unless otherwise expressly specified.

Where used herein, the term “exemplary” is intended to mean “an example of,” “serving as an example,” or “illustrative,” and does denote any preference or requirement with respect to a disclosed aspect or embodiment.

An optical system, such as a HMD, can produce a virtual image display. In contrast to methods for forming a real image, a virtual image is not formed on a display surface. That is, if a display surface were positioned at the perceived location of a virtual image, no image would be formed on that surface. Virtual image display has a number of inherent advantages for augmented reality presentation. For example, the apparent size of a virtual image is not limited by the size or location of a display surface. Additionally, the source object for a virtual image may be small; for example, a magnifying glass provides a virtual image of an object. In comparison with systems that project a real image, a more realistic viewing experience can be provided by forming a virtual image that appears to be some distance away. Providing a virtual image also obviates the need to compensate for screen artifacts, as may be necessary when projecting a real image.

An image light guide may utilize image-bearing light from a light source such as a projector to display a virtual image. For example, collimated, relatively angularly encoded, light beams from a projector are coupled into a planar waveguide by an input coupling such as an in-coupling diffractive optic, which can be mounted or formed on a surface of the planar waveguide or integrated within the waveguide. Such diffractive optics can be formed as diffraction gratings, holographic optical elements (HOEs) or in other known ways. For example, the diffraction grating can be formed by surface relief. After propagating along the waveguide, the diffracted light can be directed back out of the waveguide by a similar output coupling such as an out-coupling diffractive optic, which can be arranged to provide pupil expansion along one dimension of the virtual image. In addition, a turning grating can be positioned on/in the waveguide to provide pupil expansion in an orthogonal dimension of the virtual image. The image-bearing light output from the waveguide provides an expanded eyebox for the viewer.

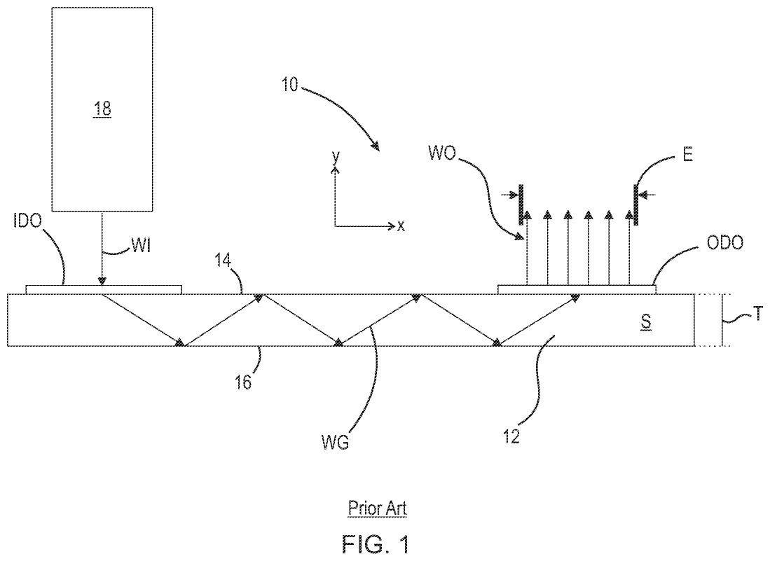

FIG. 1 is a schematic diagram showing a simplified top view of one conventional configuration of an image light guide system 10. Image light guide system 10 includes a planar image light guide 12, an in-coupling diffractive optic IDO, and an out-coupling diffractive optic ODO. The image light guide 12 includes a transparent substrate S, which can be made of optical glass or plastic, with plane-parallel front and back surfaces 14 and 16. In this example, the in-coupling diffractive optic IDO is shown as a transmissive-type diffraction grating arranged on the front surface 14 of the image light guide 12. However, in-coupling diffractive optic IDO could alternately be a reflective-type diffraction grating or other type of diffractive optic, such as a volume hologram or other holographic diffraction element, that diffracts incoming image-bearing light beams WI into the image light guide 12. The in-coupling diffractive optic IDO can be located on or embedded in front surface 14 or back surface 16 of the image light guide 12 and can be of a transmissive or reflective-type in a combination that depends upon the direction from which the image-bearing light beams WI approach the image light guide 12.

When used as a part of a near-eye or head-mounted display system, the in-coupling diffractive optic IDO of the conventional image light guide system 10, couples the image-bearing light beams WI from a real, virtual or hybrid image source 18 into the substrate S of the image light guide 12. Any real image or image dimension formed by the image source 18 is first converted into an array of overlapping, angularly related, collimated beams encoding the different positions within a virtual image for presentation to the in-coupling diffractive optic IDO. Typically, the rays within each bundle forming one of the angularly related beams extend in parallel, but the angularly related beams are relatively inclined to each other through angles that can be defined in two angular dimensions corresponding to linear dimensions of the image.

Once the angularly related beams engage with the in-coupling diffractive optic IDO, at least a portion of the image-bearing light beams WI are diffracted (generally through a first diffraction order) and thereby redirected by in-coupling diffractive optic IDO into the planar image light guide 12 as angularly encoded image-bearing light beams WG for further propagation along a length dimension x of the image light guide 12 by total internal reflection (TIR) between the plane parallel front and back surfaces 14 and 16. Although diffracted into a different combination of angularly related beams in keeping with the boundaries set by TIR, the image-bearing light beams WG preserve the image information in an angularly encoded form that is derivable from the parameters of the in-coupling diffractive optic IDO. The out-coupling diffractive optic ODO receives the encoded image-bearing light beams WG and diffracts (also generally through a first diffraction order) at least a portion of the image-bearing light beams WG out of the image light guide 12, as image-bearing light beams WO, toward a nearby region of space referred to as an eyebox E, within which the transmitted virtual image can be seen by a viewer's eye or other optical component. The out-coupling diffractive optic ODO can be designed symmetrically with respect to the in-coupling diffractive optic IDO to restore the original angular relationships of the image-bearing light beams WI among outputted angularly related beams of the image-bearing light beams WO. In addition, the out-coupling diffractive optic ODO can modify the original field points' positional angular relationships producing an output virtual image at a finite focusing distance.

However, to increase one dimension of overlap among the angularly related beams populating the eyebox E (defining the size of the region within which the virtual image can be seen), the out-coupling diffractive optic ODO is arranged together with a limited thickness T of the image light guide 12 to encounter the image-bearing light beams WG multiple times and to diffract only a portion of the image-bearing light beams WG upon each encounter. The multiple encounters along the length of the out-coupling diffractive optic ODO have the effect of replicating the image-bearing light beams WG and enlarging or expanding at least one dimension of the eyebox E where the replicated beams overlap. The expanded eyebox E decreases sensitivity to the position of a viewer's eye for viewing the virtual image.

The out-coupling diffractive optic ODO is shown as a transmissive-type diffraction grating arranged on or secured to the front surface 14 of the image light guide 12. However, like the in-coupling diffractive optic IDO, the out-coupling diffractive optic ODO can be located on or embedded within the front or back surface 14 or 16 of the image light guide 12 and can be of a transmissive or reflective-type in a combination that depends upon the direction through which the image-bearing light beams WG are intended to exit the image light guide 12. In addition, the out-coupling diffractive optic ODO could be formed as another type of diffractive optic, such as a volume hologram or other holographic diffraction element, that diffracts propagating image-bearing light beams WG from the image light guide 12 as the image-bearing light beams WO encounter the out-coupling diffractive optic ODO.

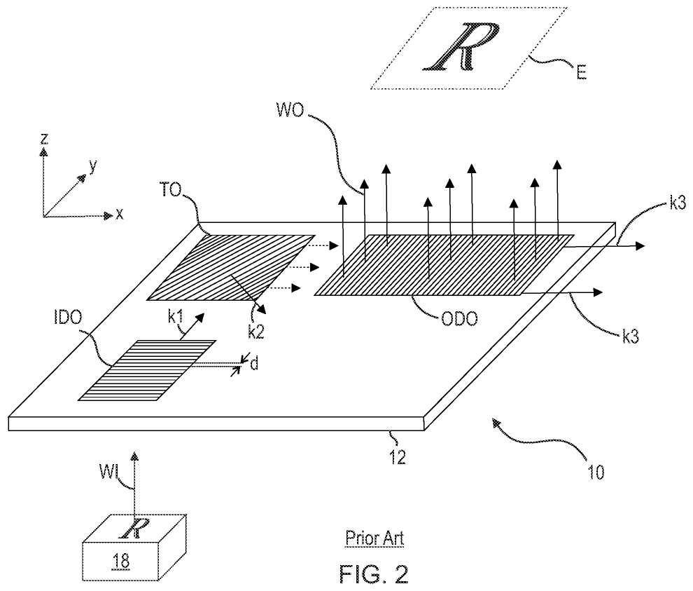

FIG. 2 illustrates a perspective view of a conventional image light guide system 10 arranged for expanding the eyebox E in two dimensions, i.e., along both x- and y-axes of the intended image. To achieve a second dimension of eyebox expansion, the in-coupling diffractive optic IDO is oriented to diffract at least a portion of image-bearing light beams WG (shown in FIG. 1) about a grating vector k1 along the image light guide 12 toward an intermediate turning optic TO, whose grating vector k2 is oriented to diffract at least a portion of the image-bearing light beams WG in a reflective mode along the image light guide 12 toward the out-coupling diffractive optic ODO. It should be appreciated that only a portion of the image-bearing light beams WG are diffracted by each of the multiple encounters with intermediate turning optic TO, thereby laterally replicating each of the angularly related beams of the image-bearing light beams WG as they approach the out-coupling diffractive optic ODO. The intermediate turning optic TO redirects the image-bearing light beams WG toward the out-coupling diffractive optic ODO (having a grating vector k3) for longitudinally replicating the angularly related beams of the image-bearing light beams WG in a second dimension before exiting the image light guide 12 as the image-bearing light beams WO. Grating vectors, such as the depicted grating vectors k1, k2, and k3, extend within a parallel plane of the image light guide 12 in respective directions that are normal to the diffractive features (e.g., grooves, lines, or rulings) of the diffractive optics and have respective magnitudes inversely proportional to the period or pitch d (i.e., the on-center distance between the diffractive features) of the diffractive optics IDO, TO, and ODO.

As shown in FIG. 2, in-coupling diffractive optic IDO receives the incoming image-bearing light beams WI containing a set of angularly related beams corresponding to individual pixels or equivalent locations within an image generated by the image source 18, such as a projector. A full range of angularly encoded beams for producing a virtual image can be generated by a real display together with collimating optics or other optical components, by a beam scanner for more directly setting the angles of the beams, or by a combination such as a one-dimensional real display used with a scanner. In this configuration, the image light guide 12 outputs a replicated set of angularly related beams (replicated in two dimensions) by providing multiple encounters of the image-bearing light beams WG with both the intermediate turning optic TO and the out-coupling diffractive optic ODO in different orientations. In the depicted orientation of the image light guide 12, the intermediate turning optic TO provides eyebox expansion in the y-axis direction, and the out-coupling diffractive optic ODO provides a similar eyebox expansion in the x-axis direction. The relative orientations and respective periods d of the diffractive features of the in-coupling optic IDO, intermediate turning optic TO, and out-coupling diffractive optic ODO provide for eyebox expansion in two dimensions while preserving the intended relationships among the angularly related beams of the image-bearing light beams WI that are output from the image light guide system 10 as the image-bearing light beams WO. It should be appreciated that the periods d of the in-coupling diffractive optic IDO, the intermediate turning optic TO, and the out-coupling diffractive optic ODO, can each include diffractive features having a common pitch d, where the common pitch d of the of each optic can be different.

In the configuration shown, while the image-bearing light beams WI input into the image light guide 12 are encoded into a different set of angularly related beams by the in-coupling diffractive optic IDO, the information required to reconstruct the image is preserved by accounting for the systematic effects of the in-coupling diffractive optic IDO. The intermediate turning optic TO, located in an intermediate position between the in-coupling and out-coupling diffractive optics IDO and ODO, can be arranged so that it does not induce significant changes to the encoding of the image-bearing light beams WG. As such, the out-coupling diffractive optic ODO can be arranged in a symmetric fashion with respect to the in-coupling diffractive optic IDO, e.g., including diffractive features sharing the same period d. Similarly, the period of the intermediate turning optic TO can also match the common period of the in-coupling and out-coupling diffractive optics IDO and ODO. Although the grating vector k2 of the intermediate turning optic TO is shown oriented at 45 degrees with respect to the other grating vectors, which remains a possible orientation, the grating vector k2 of the intermediate turning optic TO can be oriented at 60 degrees to the grating vectors k1 and k3 of the in-coupling and out-coupling diffractive optics IDO and ODO in such a way that the image-bearing light beams WG are turned 120 degrees. By orienting the grating vector k2 of the intermediate turning optic TO at 60 degrees with respect to the grating vectors k1 and k3 of the in-coupling and out-coupling diffractive optics IDO and ODO, the grating vectors k1 and k3 of the in-coupling and out-coupling diffractive optics IDO and ODO are also oriented at 60 degrees with respect to each other. By basing the grating vector magnitudes on the common pitch shared by the in-coupling, intermediate turning, and out-coupling diffractive optics IDO, TO, and ODO, the three grating vectors k1, k2, and k3 (as directed line segments) form an equilateral triangle and sum to a zero vector magnitude, which avoids asymmetric effects that could introduce unwanted aberrations including chromatic dispersion. Such asymmetric effects can also be avoided by grating vectors k1, k2, and k3 that have unequal magnitudes in relative orientations at which the three grating vectors k1, k2, and k3 sum to a zero vector magnitude.

In a broader sense, the image-bearing light beams WI that are directed into the image light guide 12 are effectively encoded by the in-coupling diffractive optic IDO, whether the in-coupling optic IDO uses gratings, holograms, prisms, mirrors, or some other mechanism. Any reflection, refraction, and/or diffraction of light that takes place at the input should be correspondingly decoded by the output to re-form the virtual image that is presented to the viewer. Whether any symmetries are maintained among the intermediate turning optic TO, the in-coupling optic IDO, and out-coupling diffractive optic ODO, or whether any change to the encoding of the angularly related beams of the image-bearing light beams WI takes place along the image light guide 12, the intermediate turning optic TO and the in-coupling and out-coupling diffractive optics IDO and ODO can be related so that the image-bearing light beams WO that are output from the image light guide 12 preserve or otherwise maintain the original or desired form of the image-bearing light beams WI for producing the intended virtual image.

As shown in FIG. 2, the letter “R” represents the orientation of the virtual image that is visible to the viewer whose eye is positioned within the eyebox E. As shown, the orientation of the letter “R” in the represented virtual image matches the orientation of the letter “R” as encoded by the image-bearing light beams WI. A change in the rotation about the z axis or angular orientation of incoming image-bearing light beams WI with respect to the x-y plane causes a corresponding symmetric change in rotation or angular orientation of outgoing light from out-coupling diffractive optic (ODO). From the aspect of image orientation, the intermediate turning optic TO simply acts as a type of optical relay, providing expansion of the angularly encoded beams of the image-bearing light beams WG along one axis (e.g., along the y axis) of the image. Out-coupling diffractive optic ODO further expands the angularly encoded beams of the image-bearing light beams WG along another axis (e.g., along the x axis) of the image while maintaining the original orientation of the virtual image encoded by the image-bearing light beams WI. The intermediate turning optic TO is typically a slanted or square grating or, alternately, can be a blazed grating and is typically arranged on one of the plane parallel front and back surfaces of the image light guide 12. It should be appreciated that the representation of the virtual image “R,” as created by an image source, is comprised of infinitely focused light that requires a lens (e.g., the lens in the human eye) to focus the image so that the orientations discussed above can be detected.

Together, the in-coupling, turning, and out-coupling diffractive optics IDO, TO, and ODO preferably preserve the angular relationships among beams of different wavelengths defining a virtual image upon conveyance by image light guide 12 from an offset position to a near-eye position of the viewer. While doing so, the in-coupling, turning, and out-coupling diffractive optics IDO, TO, and ODO can be relatively positioned and oriented in different ways to control the overall shape of the image light guide 12 as well as the overall orientations at which the angularly related beams can be directed into and out of the image light guide 12.

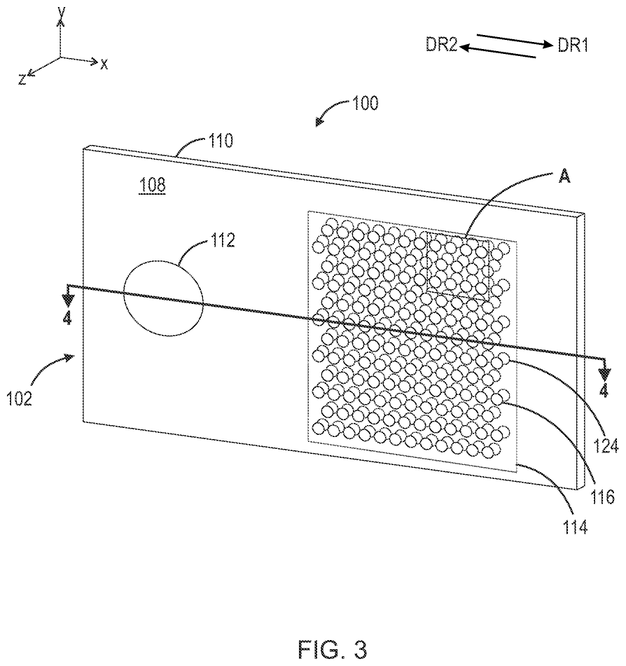

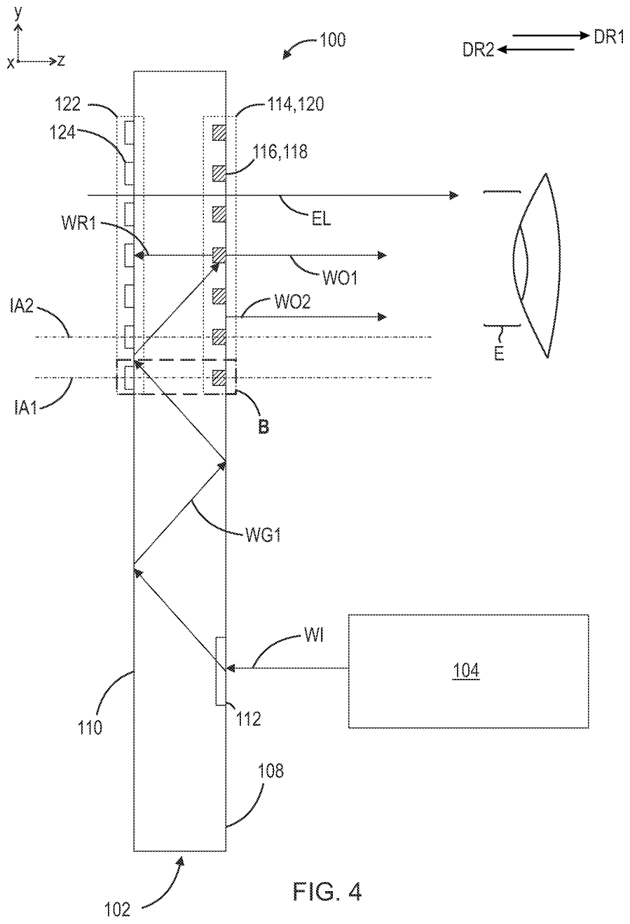

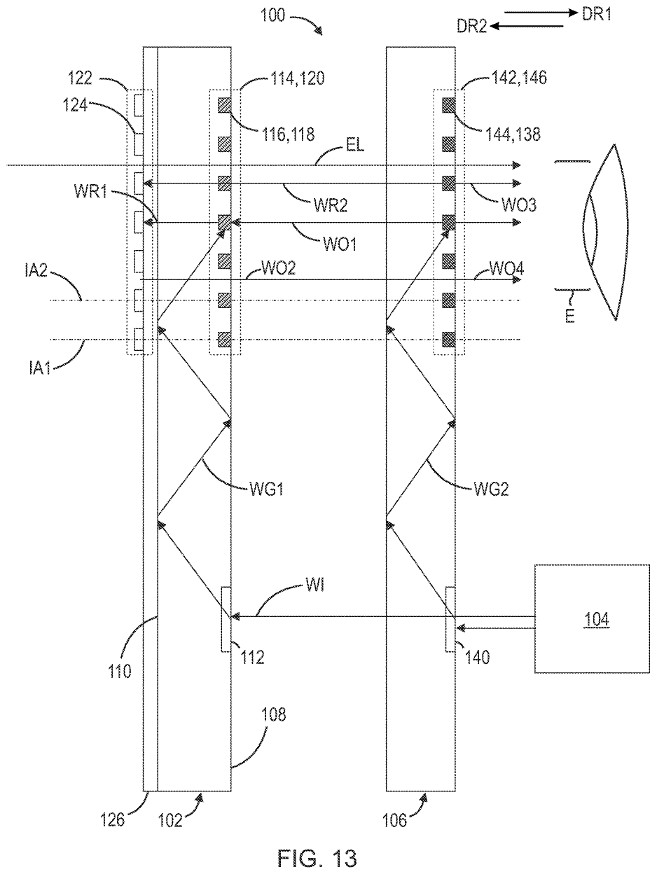

FIGS. 3 and 4 illustrate example embodiments of an image light guide system 100 according to the present disclosure. Specifically, FIG. 3 illustrates a schematic, front-perspective view of an image light guide 102 of image light guide system 100, and FIG. 4 illustrates a schematic, cross-sectional view of an image light guide 102 of image light guide system 100 taken generally along section line 4-4 in FIG. 3. FIG. 4 also includes a schematic depiction of an image source system 104. In some examples, as illustrated and described with respect to FIG. 13, the image light guide 102 is a first image light guide 102 and image light guide system 100 can also include at least a second image light guide 106, forming an image light guide stack. As such, the description that follows may utilize “image light guide 102” and “first image light guide 102,” interchangeably, and/or utilize “image light guide 106” and “second image light guide 106,” interchangeably.

Continuing with FIGS. 3 and 4, in some examples, image source system 104 is formed as a projector or self-emitting display operable to generate a full range of angularly encoded image-bearing light to be conveyed by the one or more image light guides, e.g., image light guide 102, to an eyebox E (shown in FIG. 4). In some examples, the image source system 104 can include a light source and/or some form of Spatial Light Modulator (SLM) to form one or more images from the light generated by the light source. For example, the light source can include one or more light-emitting diodes (LEDs), organic LEDs (OLEDs), micro-LEDs (μLEDs), or semiconductor lasers. In other examples, the image source system is a color field sequential projector system operable to pulse image-bearing light of multiple wavebands, for example light from within red, green, and blue wavelength ranges. The light from the light source can be formed into one or more images via interaction with an SLM, e.g., a Liquid Crystal Display (LCD), a Liquid Crystal on Silicon (LCoS) Display. or a Digital Light Processing (DLP) Display or micro-mirror array. The LCD and LCoS displays can include one or more individually addressable components operable to electrically bias portions of a liquid crystal matrix to form an image, on a pixel-by-pixel basis, using the light generated by the light source. Similarly, the light source light may be directed to one or more individually addressable components of a DLP or micro-mirror array which can be actuated to selectively reflect light generated by the light source toward an exit pupil of the image source system 104. In some examples, the image-source system 104 may comprise a self-emitting display formed of a plurality of individually addressable light sources, e.g., μLEDs, OLEDs, etc. In these examples, the individually addressable light sources also act as the SLM in that the light sources can be turned on, off, or dimmed as needed to directly form the image generated, on a pixel-by-pixel basis, by the image-source system 104.

In other examples, image source system 104 includes one or more pico-projectors, where each pico-projector is configured to produce a single primary color band (e.g., red, green, or blue). In another example, image source system 104 includes a single pico-projector arranged to produce all three primary color bands (e.g., red, green, and blue). In one example, the three primary color bands are a green band having a wavelength in the range between 495 nm and 570 nm, a red band having a wavelength in the range between 620 nm and 750 nm, and a blue band having a wavelength in the range between 420 nm and 495 nm. The light generated by the pico-projector, once coupled and transmitted through an image light guide, e.g., image light guide 102, can be used by image light guide system 100 to form one or more virtual images viewable by a user's eye positioned within the eyebox E. Although not expressly illustrated, it should be appreciated that the image source system 104 may also include additional optical elements, e.g., collimators, homogenizers, light pipes, lenslet arrays, lenses, mirror arrays, etc., to help mix, focus, or direct light generated by the light source out of the image source system 104 and toward the image light guide and/or eyebox E.

FIGS. 3 and 4 illustrate other exemplary features of image light guide 102. For example, image light guide 102 can be formed as a transparent planar substrate, having plane-parallel front and back surfaces, i.e., a first planar surface 108 and a second planar surface 110 opposite the first planar surface 110. It should be appreciated that, in some examples, first surface 108 and second surface 110 can be curved surfaces disposed parallel to each other rather than planar surfaces. Image light guide 102 can further include a first in-coupling diffractive optic 112, which can be arranged on, along, in, or otherwise engaged with the first planar surface 108 and be configured as a transmissive-type diffractive optic. It should be appreciated that, in some examples, first in-coupling diffractive optic 112 can also be arranged on, in, along, or otherwise engaged with the second planar surface 110 and be of a reflective-type diffractive optic. In-coupling diffractive optic 112 can be formed as a set of diffraction gratings, e.g., linear or post-shaped surface-relief gratings, one or more holographic optical elements (HOEs), or other known diffraction optics, and is configured to receive image-bearing light WI (shown in FIG. 4) generated by the image source system 104 and couple at least a portion of the image-bearing light WI into the image light guide 102 at an angle that satisfies a TIR condition of the image light guide 102, such that the coupled image-bearing light WG1 propagates between the plane-parallel surfaces. i.e., first and second planar surfaces 108, 110 along a length dimension of the image light guide 102.

Image light guide 102 can also include a first out-coupling diffractive region 114. First out-coupling diffractive region 114 describes area arranged on, in, or engaged with the first planar surface 108 or the second planar surface 110 and be configured as a transmissive or reflective-type diffractive region. In some examples, as illustrated in FIGS. 3 and 4, first out-coupling diffractive region 114 includes a first plurality of out-coupling diffractive sub-regions 116 (collectively referred to herein as “sub-regions 116” or “plurality of sub-regions 116” or referred to in the singular as “sub-region 116”). Each sub-region 116 can include a plurality of diffractive features configured and/or optimized to receive coupled image-bearing light WG1 and out-couple, via diffraction, at least a portion of the image-bearing light WG1 in a first direction DR1 (shown in FIG. 4) toward the eyebox E, while preserving the angularly-encoded arrangement of the image-bearing light such that one or more virtual images are formed in the eyebox E that correspond to the one or more images generated by the image source system 104. The diffractive features can be diffraction gratings, e.g., linear or post-shaped surface-relief gratings, one or more holographic optical elements (HOEs), or other known diffraction optics that are configurable to optimally diffract image-bearing light of one or more particular wavelength ranges. Image light guide 102 may optionally include a turning grating arranged on, in, or engaged with the first or second planar surfaces 108, 110, and optically positioned between the first in-coupling diffractive optic 112 and the first out-coupling diffractive region 114. Such a turning grating may operate to rotate or otherwise convey the image-bearing light and provide an additional dimension of expansion to the eyebox E reducing positional sensitivity of the location of the eyebox relative to the user's eye.

In some examples, as shown in FIG. 4, the diffractive features within each sub-region 116 are linear diffractive features and have a common pitch or spacing between each feature forming a first fine periodic pattern 118 of diffractive features. It should be noted that only one sub-region 116 is labelled in FIG. 4 for clarity. The first fine periodic pattern 118 can include a common pitch in the nanometer range or several hundred nanometer range, e.g., the distance between any two individual linear diffractive features may be between 300-750 nm and is uniform across and within each sub-region 116. When coupled image-bearing light WG1 engages with the first fine periodic pattern 118 within each sub-region 116, at least a portion of the coupled image-bearing light WG1 is out-coupled as a first portion of out-coupled image-bearing light WO1 in the first direction DR1 toward eyebox E. Additionally, upon engaging the diffractive features of the sub-regions 116, at least a portion of the coupled image-bearing light WG1 is reflected in the second direction DR2, opposite direction DR1, as a first reflected portion of image-bearing light WR1. It should be appreciated that, in some examples, the common pitch between diffractive features of a given region, may vary across one or more dimensions of the out-coupling diffractive region 114. For example, a first sub-region may have a first common pitch while a second sub-region, spaced apart from the first sub-region along a dimension of the out-coupling diffractive region 114 can have a second common pitch that is different than the first. As such, the common pitch can vary progressively or in a step-wise manner across at least one dimension, e.g., the x and/ory dimension of the out-coupling diffractive region 114.

Additionally, the sub-regions 116 can be spaced apart from each other in a first coarse periodic pattern 120 that also influences the diffraction of image-bearing light WG1. In other words, the spacing between each sub-regions 116 may form an additional, coarse, periodic pattern that diffracts at least a second portion of image-bearing light WO2 out of the image light guide 102 in the first direction DR1 toward the eyebox E and contributes to the diffraction of light as it exits the image light guide 102. The spacing between each sub-region 116, i.e., the first course periodic pattern 120, can be in the millimeter range, e.g., the distance between centers of any two individual sub-regions 116 may be between 0.5-3.5 millimeters. In some examples, the diffraction pattern induced by the first fine-periodic pattern 118 and the diffraction pattern induced by the first course periodic pattern 120 form a single wavefront of diffracted image-bearing light that exists the first image light guide 102 in the first direction DR1 toward the eyebox E.

Although the first coarse periodic pattern 120 is illustrated using a two-dimensional grid or matrix of sub-regions 116, where the spacing between each sub-region 116 is uniform, it should be appreciated that the spacing of the sub-regions 116 within the out-coupling diffraction region 114 can be randomized or pseudorandomized. The two-dimensional grid of sub-regions 116 can collectively form a rectangular, hexagonal, or some other periodic pattern. Also, the spacing may vary progressively or in a stepwise manner, also referred to as “chirped,” along any dimension of the out-coupling diffractive region 114, e.g., along the x dimension (into or out of the page in FIG. 4) and/or the y dimension vertically in FIG. 4).

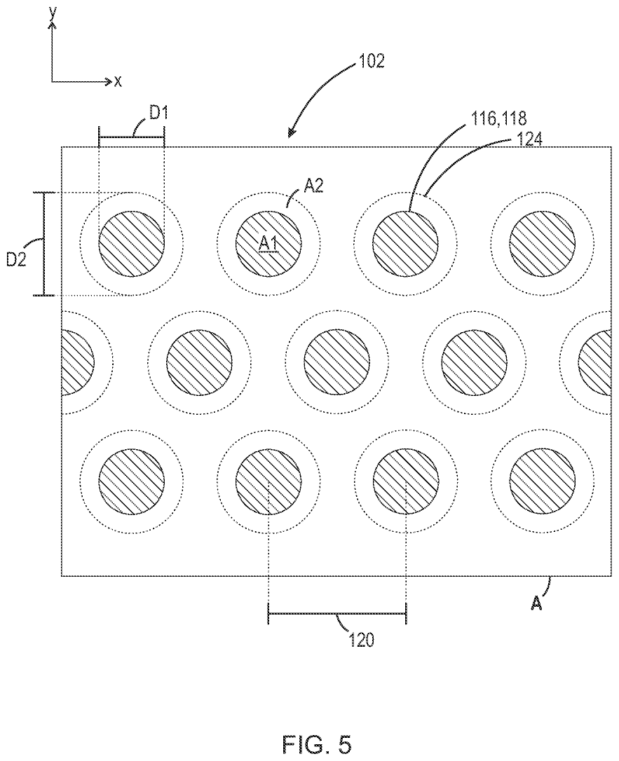

FIG. 5, which illustrates an enlarged, front-elevational view of portion A from FIG. 3 with a hexagonal grid of sub-regions 116, shows that each sub-region 116 of the plurality of sub-regions 116 have an area A1 and can be circular in shape, i.e., where the bounded or unbounded area of each sub-region 116 forms the shape of a circle. Although illustrated as a plurality of circular sub-regions 116, it should be appreciated that the sub-regions 116 may be formed of any other shape, e.g., square, oval, triangular, rectangular, elliptical, hexagonal, octagonal, diamond shaped, etc. In examples where the sub-regions 116 are circular, each sub-region 116 can also include a diameter D1.

As described above with respect to FIG. 4, the first fine periodic pattern 118 of diffractive features within each sub-region 116 acts to diffract portions of coupled image-bearing light WG1 in two directions, i.e., diffract a first portion WO1 in first direction DR1 toward the eyebox E for viewing by the viewer, and a first reflected portion WR1 in a second direction DR2 away from the eyebox E. If the first reflected portion of image-bearing light WR1, also referred to herein as “forward light”, is allowed to exit the image light guide system 100, an observer of the image light guide system 100 may be able to see one or more virtual images representative of the one or more images generated by the image source system 104, which may compromise user and data security, and may aesthetically look displeasing. As such, the present disclosure provides systems and methods to block this forward light, i.e., the first reflected portion of image-bearing light WR1 from leaving the image light guide system 100.

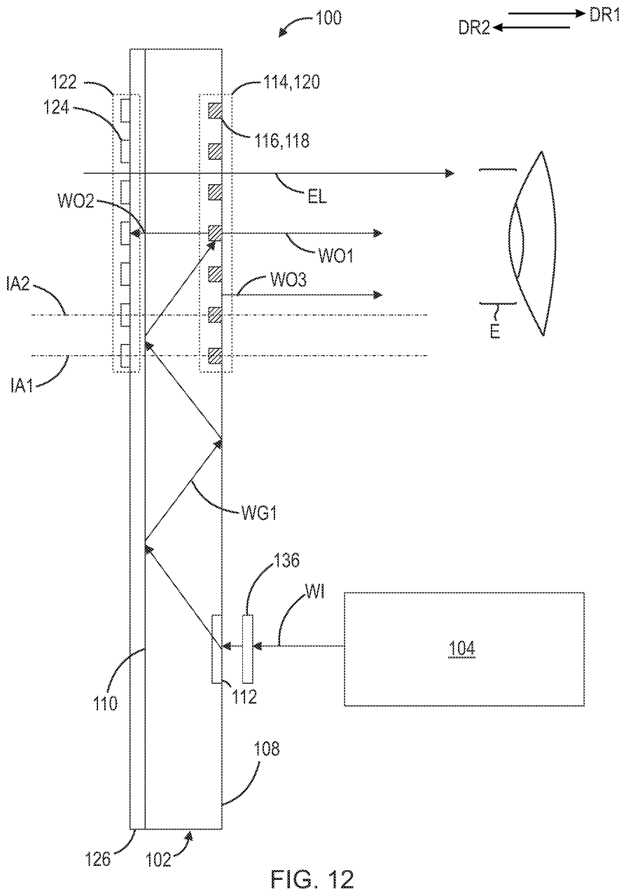

As illustrated in FIGS. 3-5 and 7-12, in order to prevent the forward light, i.e., first reflected portion of image-bearing light WR1, from leaving the image light guide system 100, image light guide system 100 can include a blocking region 122 (shown in FIG. 4). Blocking region 122 can be a bounded or unbounded area arranged on, in, along, or engaged with the first planar surface 108 or the second planar surface 110. In other examples described below, blocking region 122 can be positioned on, in, along, or engaged with one or more surfaces of a cladding layer 126 or a support substrate 128. Blocking region 122 can include a first plurality of blocking features 124 (collectively referred to herein as “blocking features 124” or “plurality of blocking features 124”). Each blocking feature 124 is arranged to block or reflect a portion of image-bearing light, e.g., first reflected portion of image-bearing light WR1, preventing the first reflected portion of image-bearing light WR1 from exiting the image light guide system 100. As such, each blocking feature 124, can comprise an absorptive material or a reflective material. In some examples, the absorptive material is selected from at least one of: an opaque material, e.g., glass, plastic, metal, dichroic thin-film, or a dark or opaque ink, e.g., black ink. In some examples, the reflective material is selected from any diffusive or specularly reflective material, e.g., mirrored or silver-coated glass or aluminum. In some examples, the absorptive material and/or the reflective material is located, positioned, or otherwise disposed on one or more surfaces of the image light guide 102, e.g., first planar surface 108 or second planar surface 110, or on one or more surfaces of a cladding layer 126 (discussed below) or one or more surfaces of a support substrate 128 (discussed below). In some examples, the absorptive material and/or the reflective material are integrated within or impregnated within the substrate material of the image light guide 102, within the cladding layer 126 (discussed below), or within the support substrate 128 (discussed below). In some examples, as illustrated and described below with respect to FIG. 12, the absorptive material and/or the reflective material is formed as a polarizer. e.g., a linear polarizer. In examples where the blocking features 124 are reflective, the forward light, i.e., first reflected portion WR1, will reflect back in the first direction DR1 upon contact with blocking features 124. In examples where the reflective blocking features 124 are located on, in, or engaged with a surface that is parallel with the surfaces of the image light guide 102, the angular encoding of the image-bearing light will be preserved upon reflection and may propagate in the first direction DR1 and into the eyebox E increasing the light intensity and brightness of the virtual images formed within the eyebox E. In addition to comprising the security or privacy of the user by preventing leakage of the forward light to an outside observer, the presence of the blocking features also reduces but does not eliminate the amount of environmental light that passes through the image light guide 102 and into the user's eye. As such the light generated by the image source system 104 does not need to compete with 100% of the environmental light and may increase the perceived brightness of the virtual images and improve overall user experience.

As shown in FIGS. 3 and 5, in some examples, image light guide system 100 includes at least one blocking feature 124 for each respective sub-region 116. Additionally, each blocking feature 124 of the plurality of blocking features has a shape that matches the shape of each respective sub-region 116. For example, as shown in FIGS. 3 and 5, if the sub-regions 116 are circular, each respective blocking feature 124 is also circular. Alternatively, should the sub-regions 116 take another shape, e.g., square, triangular, hexagonal, etc., each blocking feature 124 will be square, triangular, or hexagonal, respectively. It should be appreciated that in other examples, the shape of the sub-regions 116 does not need to match or be complimentary to the shape of each respective blocking feature 124. For example, should each sub-region 116 be circular, the shape of each respective blocking feature 124 may be a different shape, e.g., square. Additionally, more than one shape may be present within the plurality of sub-regions 116 or blocking features 124. For example, one or more sub-regions 116 may be formed as a first shape, e.g., circular, while another sub-region 116 is formed as a second shape, e.g., a square. Similarly, one or more blocking features 124 may be formed as a first shape, e.g., circular, while another blocking features 124 is formed as a second shape, e.g., a square.

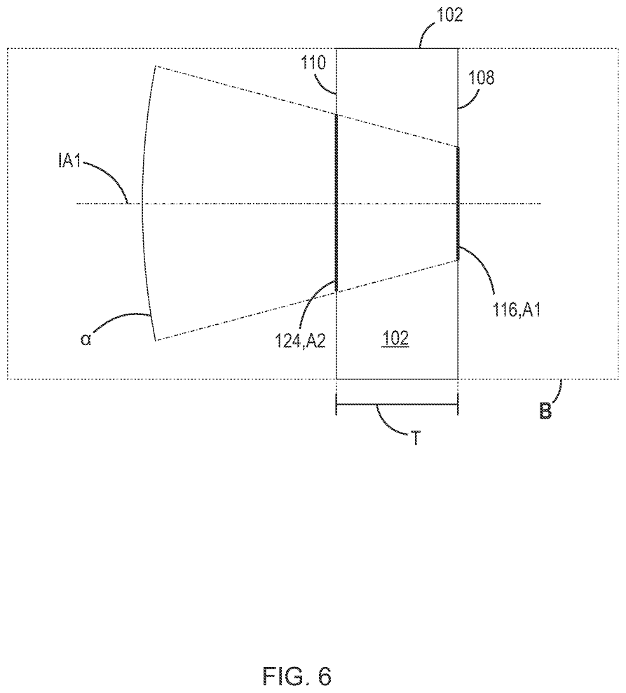

In some examples, each sub-region 116 is aligned with a respective blocking feature 124. For example, as illustrated in FIGS. 4-6, each sub-region 116 and its respective blocking feature 124 are centered on and about an imaginary axis of a plurality of imaginary axes. As shown, in one exemplary embodiment, each imaginary axis, e.g., imaginary axis IA1 or imaginary axis IA2, is arranged to pass through the first planar surface 108 of the image light guide 102, pass through at least one sub-region 116, pass through at least one blocking feature 124, and pass through the second planar surface 110 of the image light guide 102. In another exemplary embodiment, each imaginary axis, e.g., imaginary axis IA1, is arranged to pass through the first planar surface 108 of the image light guide 102, pass through the center of at least one sub-region 116, pass through the center of at least one blocking feature 124, and pass through the second planar surface 110 of the image light guide 102. In some examples, as shown in FIGS. 4 and 6, the imaginary axes are also arranged to pass through cladding layer 126 (discussed below) and/or the support substrate 128 (also discussed below).

FIG. 6, illustrates a side-elevational view of section B from FIG. 4. As shown in FIGS. 5 and 6, and described above, each respective sub-region 116 has an area A1. Additionally, each respective blocking feature 124 has an area A2 that is equal to or larger than area A1. In some examples, A1 for each sub-region 116 is chosen such that the out-coupling efficiency of the first portion of image-bearing light WO1 is above a predetermined threshold, e.g., above 30%, 40%, 50%, 60%, 70%, 80%, etc. Where sub-regions 116 and blocking features 124 are circular, the area of a single sub-region 116, i.e., area A1, can be used to determine the area A2 of its corresponding blocking feature 124 as a function of: i) distance T between the sub-region 116 and the corresponding blocking feature 124; ii) the desired field of view α of the image light guide system 100; and, iii) the selected area A1 of the sub-region 116, using the following equation:

$$A 2 = π ( \sqrt{\frac{A 1}{π}} + {( T * Tan ( \frac{α}{2} ) )}^{2} \qquad Eq . 1$$

Conversely, the area A2 of the individual blocking features 124 can be optimally selected based on minimizing how visually obtrusive their appearance is to outside observers or the user of the image light guide system 100. For example, since the blocking features 124 will necessarily block an outside observer's view of the user's face and may therefore create noticeable artifacts on the transparent image light guide when viewing the user of the image light guide system 100, it may be desirable to limit the amount of total area within the blocking region 122 that is taken up by the combined areas A2 of the plurality of blocking features 124, such that the total area (i.e., the sum of the areas A2 of each blocking feature 124 within the blocking region 122) blocked by the blocking features 124 equals no more than 50% of the total area within blocking region 122. As such, starting with a desired value for A2, i.e., a desired area for each blocking feature 124, area A1 may be derived as a function of: i) distance T; ii) the desired field of view α of the image light guide system 100; and, iii) the selected area A2 of the blocking features 124, using the following equation:

$$A 1 = π ( \sqrt{\frac{A 2}{π}} - {( T * Tan ( \frac{α}{2} ) )}^{2} \qquad Eq . 2$$

As such, whether A1 or A2 is selected for, or optimized for, first, the area of the corresponding blocking feature 124 or sub-region 116 can be solved for using Equation 1 or Equation 2, respectively. It should be appreciated that, in exemplary embodiments the variable T described above represents the distance between any given sub-region 116 and its corresponding blocking feature 124. As such, in example embodiments described below, where image light guide system 100 includes a cladding layer 126 (discussed below) and/or a support substrate 128 (discussed below), distance T represents the distance between the sub-region 116 and its corresponding blocking feature 124 rather than only the thickness of the substrate used to form image light guide 102. Those skilled in the art will also appreciate that for example embodiments where the blocking region 122 is disposed on, in, or engaged with one or more surfaces of a cladding layer 126 or support substrate 128, additional variables may need to be added and/or Equations 1 and 2 may need to be altered to adjust for diffraction of light as it exits the substrate of the image light guide 102 and propagates toward through or in the direction of the cladding layer 126 and/or the support substrate 128.

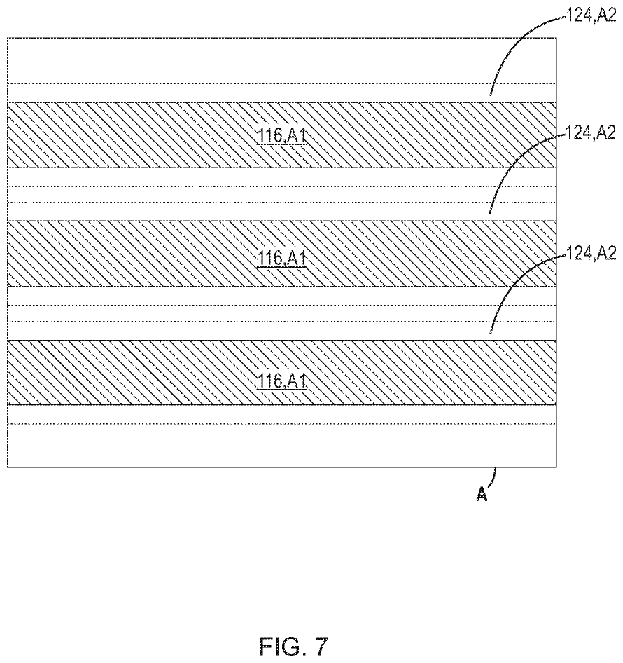

In some examples, as shown in FIG. 7, which illustrates an alternative configuration of section A shown in FIG. 3, sub-regions 116 and blocking features 124 are linear or rectangular in shape. In this alternative configuration, should the area A1 of the sub-regions 116 be chosen, or optimized for, first, the area A2 of the corresponding blocking feature 124 can be derived from the following equation, where L is the length of the sub-region 116 within the diffractive region 114.

$$A 2 = L ( \frac{A 1}{L} + 2 ( T * Tan ( \frac{α}{2} ) ) \qquad Eq . 3$$

Alternatively, should A2 be chosen, or optimized for, first, the area A1 of the corresponding sub-region 116 can be derived from the following equation.

$$A 1 = L ( \frac{A 2}{L} - 2 ( T * Tan ( \frac{α}{2} ) ) \qquad Eq . 4$$

Similarly to the circular examples above, those skilled in the art will also appreciate that for example embodiments where the blocking region 122 is disposed on, in, or engaged with one or more surfaces of a cladding layer 126 or support substrate 128, additional variables may need to be added and/or Equations 3 and 4 may need to be altered to adjust for diffraction of light as it exits the substrate of the image light guide 102 and propagates toward through or in the direction of the cladding layer 126 and/or the support substrate 128.

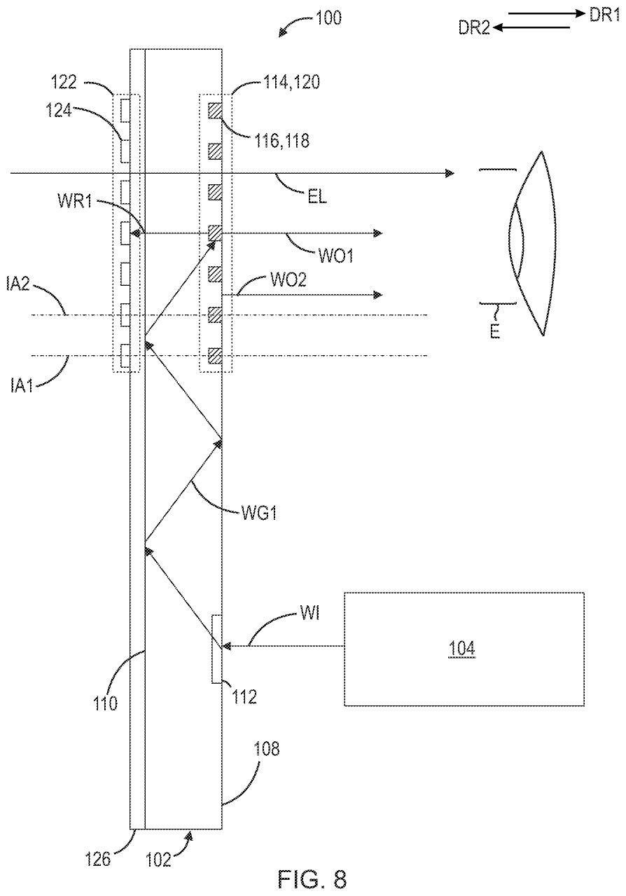

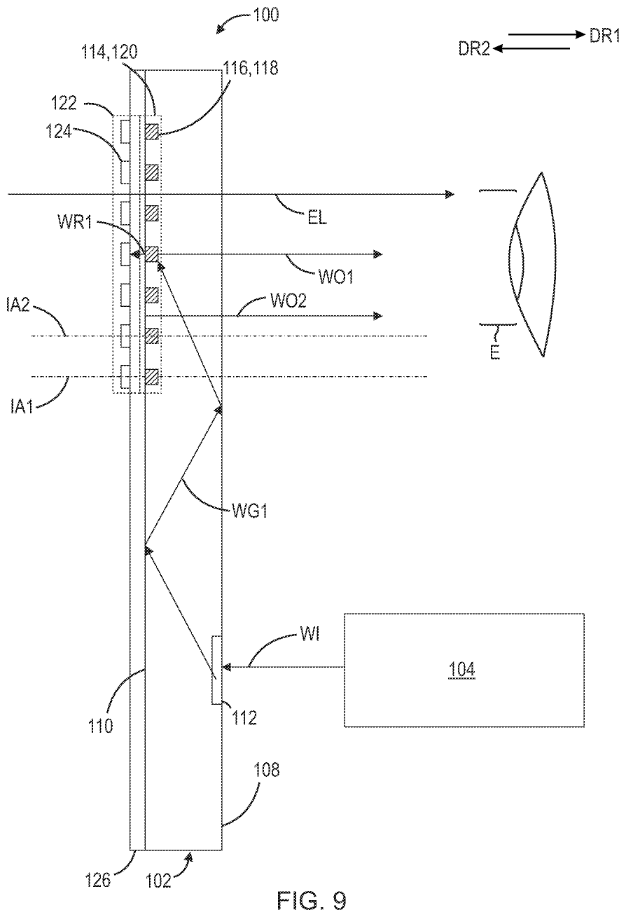

FIGS. 8-9, which illustrate side-elevational views of example image light guide systems 100 according to the present disclosure, the plurality of blocking features 124 can be disposed on, in, or engaged with cladding layer 126 rather than directly engaged with one or more surfaces of the image light guide 102. The cladding layer 126 can be made of any transparent material, e.g., silica, fused silica, glass, polymer, adhesive, etc., that has an index of refraction that is less than the index of refraction of the material used to form image light guide 102. For example, should the image light guide 102 comprise a transparent material having an index of refraction between 1.5 and 2.0, the index of refraction of the cladding layer 126 will be lower, e.g., selected from the range of 1.1-1.49. In FIG. 8, the plurality of sub-regions 116 of the out-coupling diffractive region 114 are formed on, in, or engaged with the first planar surface 108 of the image light guide 102 while the plurality of blocking features 124 of the blocking region 122 or are arranged on, in, or engaged with a surface of the cladding layer 126 that is opposite the first planar surface 108. As shown, the difference in the index of refraction between the substrate material of the image light guide 102 and the material of the cladding layer 126 maintains the TIR condition of the coupled image-bearing light WG1 between the first planar surface 108 and the second planar surface 110 of the image light guide 102. In some examples, the cladding layer 126 is desirable because positioning the blocking features 124 directly on the second planar surface 110 of the image light guide 102 may affect the TIR condition and/or may attribute to attenuation/absorption caused of coupled light by the material used to form the blocking features 124. This result can be avoided by using a low index cladding layer 126 to separate the TIR interface from the location or position of the blocking features 124.

FIG. 9 illustrates another example configuration of image light guide system 100 where the image light guide system 100 incudes a cladding layer 126 and the plurality of diffractive sub-regions 116 can be located on, in, or engaged with the second planar surface 110 of the image light guide 102. In this example, the TIR condition for coupled image-bearing light WG1 is maintained via the interface between the cladding layer 126 and the second planar surface 110 of image light guide 102, and the diffractive sub-regions 116 operate as a reflective-type diffraction grating. By position the out-coupling diffractive region 114 and plurality of diffractive sub-regions 116 on, in, or engaged with the second planar surface 110 in a reflective-type diffraction arrangement, the distance T between each pair of sub-regions 116 and blocking features 124 can be minimized. Using equations 1-4 above, it can be seen that minimizing the distance T between these features results in less of a difference between the respective areas A1 and A2. As a result, the area A1 of each sub-region 116 can be increased (which increases the total out-coupling efficiency of the out-coupling diffractive region 114), or alternately, the area A2 of each blocking feature can be decreased (minimizing the observable amount of blocked area to an outside observer and increasing the amount of real-world light or environmental light EL that can pass through the image light guide 102).

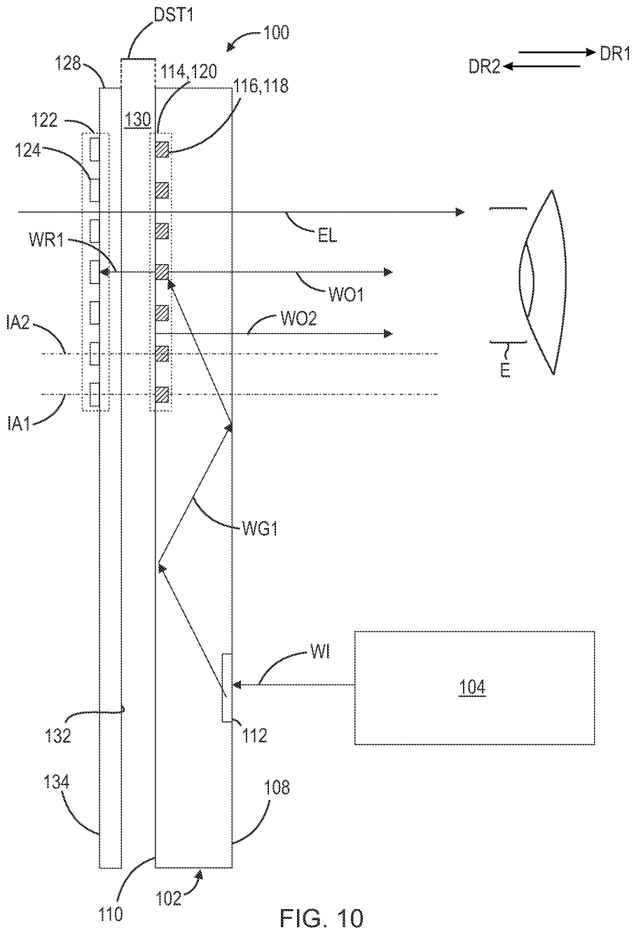

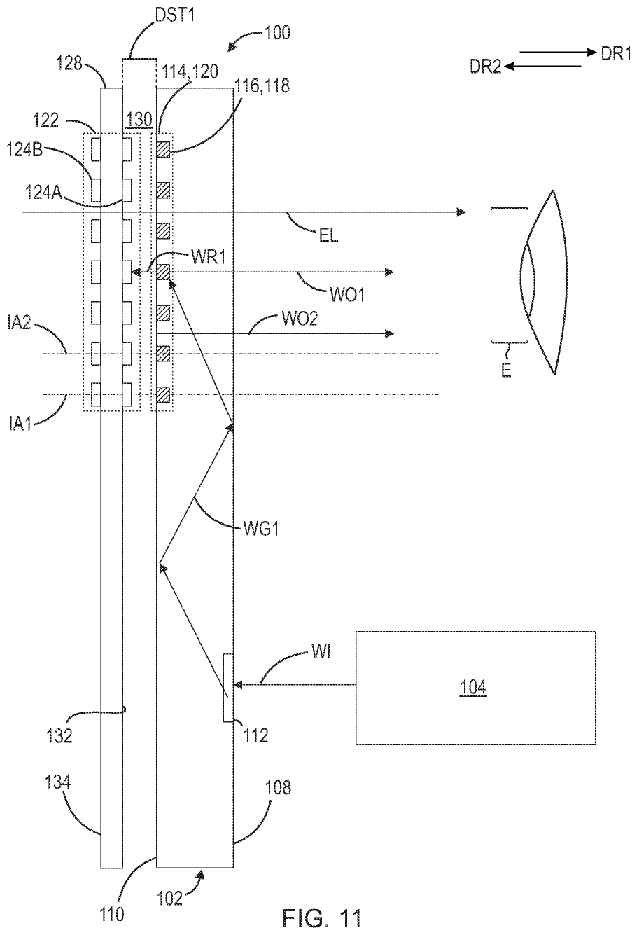

In some examples, shown in FIGS. 10-11, image light guide system 100 includes a support substrate 128 positioned a first distance DST1 from the image light guide 102 forming an air-gap 130 therebetween. The air-gap 130 provides a difference in the index of refraction along the second planar surface 110 of the image light guide 102 such that the TIR condition for coupled image-bearing light WG1 is maintained without any interference or attenuation caused by the material use to form blocking features 124. The support substrate 128 can be made or formed of any transparent material with suitable optical quality, for example, a material selected from at least one of: silica, fused silica, quartz, fused quartz, glass, and polymer. As shown in these examples, the support substrate 128 can include one or more plane-parallel surfaces, e.g., third planar surface 132 and/or fourth planar surface 134. As shown in FIG. 10, the blocking region 122 having a plurality of blocking features 124 is located on, in, or otherwise engaged with one or more plane-parallel surfaces of the support substrate 128, e.g., fourth planar surface 134. As described above, any forward light, e.g., first reflected portion of image-bearing light WR1 that exists the image light guide 102 in the second direction DR2 will be blocked or reflected by one or more blocking features of the plurality of blocking features 124.

In the examples described above, should the blocking features 124 of blocking region 122 comprise reflective materials, an outside observer would see a plurality of reflective portions within the blocking region 122 giving the appearance of a mirrored surface or partially mirrored surface when looking at a user wearing a head-mounted display utilizing the image light guide system 100 described. To prevent this possible result, and as shown in FIG. 11, the plurality of blocking features 124 can comprise a first plurality of blocking features 124A and a second plurality of blocking features 124B. The first plurality of blocking features 124A can be positioned on, in, or engaged with the third planar surface 132 of the support substrate 128 while the second plurality of blocking features 124B can be positioned on, in, or engaged with the fourth planar surface 134 of the support substrate 128. As shown in FIG. 11, each respective blocking feature of the first plurality of blocking features 124A is aligned with a respective blocking feature of the second plurality of blocking features 124B, i.e., centered around or about a common imaginary axis (e.g., IA1 or IA2). In these examples, the first plurality of blocking features 124A can comprise a reflective material while the second plurality of blocking features 124B can comprise absorptive materials. In this way, the forward light, i.e., first reflected portion WR1, is reflected back in the first direction DR1 toward the eyebox E by the first plurality of blocking features 124A. Additionally, as each blocking feature of the first plurality of blocking features 124A are aligned with a respective blocking feature of the second plurality of blocking features 124B, the outside observer will not see a mirrored surface as the respective mirrored blocking features of the first plurality of blocking features 124A will be obscured or visually blocked by a respective blocking feature of the second plurality of blocking features 124B comprising an absorptive material. It should be appreciated that, in example embodiments where the blocking features 124 are reflective and arranged on the third planar surface 132 of a support substrate 128 or other structure forward of the image light guide 102, the third planar surface 132 should be arranged parallel with one or more surfaces of the image light guide 102. If the third planar surface is arranged parallel with one or more surface of the image light guide 102, the light reflected back off the blocking features 124 will add to the light entering the eyebox E and increase the brightness of the virtual image as seen by the observer. In other examples, the support substrate 128 includes only the blocking features 124B shown in FIG. 10, where the blocking features 124B comprise an absorptive material and are disposed on, in, or engaged with the third planar surface 132 of the support substrate 128. In this example, additional reflective blocking features 124A are not necessary. In further examples, image light guide system 100 includes a support substrate 128 having only reflective blocking features 124A where an additional laver or coating of absorptive material is located between the individual blocking features 124A and the support substrate 128.

In some examples, as illustrated in FIG. 12, the image light guide system 100 may utilize crossed polarizers to block the forward light. For example, image source system 104 may produce linearly polarized light or may direct image-bearing light WI through a transmissive linear polarizer 136 having a first orientation. In this example, the coupled image-bearing light WG1 will be linearly polarized in a first polarization orientation. The plurality of blocking features 124 can be formed as a plurality of polarizers, e.g., a plurality of linear polarizers, where each linear polarizer that forms the blocking features 124 are oriented in a second orientation rotated 90 degrees with respect to the first orientation. As such, image source system 104 may produce linearly polarized light of a first polarization orientation while the plurality of blocking features 124 (formed as linear polarizers) can be rotated 90 degrees with respect to the first orientation. In this way, forward light reflected in second direction DR2 will be linearly polarized light and will be blocked from escaping or exiting the image light guide system 100 when that polarized forward light engages with a plurality of polarized blocking features with a crossed or rotated polarization axis. It should be appreciated that the second orientation can be rotated to other degrees relative to the first polarization orientation, such that the second orientation is optimally chosen to block the maximum amount of light for any given configuration.

In any of the foregoing example embodiments, e.g., in the example embodiments illustrated and described with respect to FIGS. 3-12, it should be appreciated that one or more sub-regions 116 may be optimized to in-couple image-bearing light of specific wavelength ranges. For example, one or more sub-regions 116 can utilize first fine periodic pattern 118 and can be optimized to out-couple, via diffraction, a portion of image-bearing light WG1 that is within a first wavelength range, e.g., light associated with red light (between 620 nm and 750 nm). Additionally, should one or more sub-regions 116 include a second fine periodic pattern different than the first fine periodic pattern 118, the second fine periodic pattern 136 (shown in FIG. 13) can be optimized to out-couple, via diffraction, another portion of image-bearing light WG1 that is within a second wavelength range, e.g., light associated with green light (between 495 nm and 570 nm) or blue light (between 450 nm and 495 nm).

In some examples, as shown in FIG. 13, the image light guide system 100 includes more than one image-light guide, e.g., a first image light guide 102 and a second image light guide 106, arranged to form an image light guide stack. As depicted, first image light guide 102 can include any and all of the features described and illustrated with respect to FIG. 8; however, it should be appreciated that first image light guide 102 can include any and all of the features or exemplary configurations illustrated and described with respect to FIGS. 3-12. In these examples, the second image light guide 106 includes a second in-coupling diffractive optic 140 and a second out-coupling diffractive region 142 comprising a plurality of out-coupling diffractive sub-regions 144 (collectively referred to as “sub-regions 144” or “plurality of sub-regions 144”). The second in-coupling diffractive optic 140 is configured to receive image-bearing light WI from the image source system 104 and in-couple, via diffraction, at least a portion of that light as WG2 at an angle that satisfies the TIR condition of the image light guide 106, such that image-bearing light WG2 propagates along a length dimension of image light guide 106 toward the second out-coupling diffractive region 142. When image-bearing light WG2 engages with one or more sub-regions of the second plurality of diffractive sub-regions 144, a third portion of image-bearing light WO3 is out-coupled in the first direction DR1 and forms a virtual image in the eyebox E. Additionally, a second reflected portion of image-bearing light WR2 is reflected in second direction DR2 toward the first image light guide 102, which continues until it is blocked from exiting the image light guide system 100 upon engaging with the plurality of blocking features 124.

In similar fashion to first out-coupling diffractive region 114, each sub-region 144 of the second out-coupling diffractive region 142 can comprises a fine periodic pattern, e.g., first fine periodic pattern 118 or second fine periodic pattern 138. In one example, as illustrated in FIG. 13, the sub-regions 144 of the second out-coupling diffractive region 142 comprise a second fine periodic pattern 138 while the sub-regions 116 of the first out-coupling diffractive region 114 comprise a first fine periodic pattern 118. In other words, one image light guide within the stack may be optimized for in-coupling, propagation through TIR, and out-coupling of first wavelength range of image-bearing light, while the other image light guide is optimized for in-coupling, propagation through TIR, and out-coupling of a second wavelength range of image-bearing light.

Additionally, the sub-regions 144 can be spaced apart from each other in a second coarse periodic pattern 146 that also influences the diffraction of image-bearing light WG2. In other words, the spacing between each sub-region 144 may form an additional, coarse, periodic pattern that diffracts at least a fourth portion of image-bearing light WO4 out of the image light guide 106 in the first direction DR1 toward the eyebox E and contributes to the diffraction of light as it exits the image light guide 106. The spacing between each sub-region 144, i.e., the second coarse periodic pattern 146, can be in the millimeter range, e.g., the distance between centers of any two individual sub-regions 144 may be between 0.5-3.5 millimeters. In some examples, the diffraction pattern induced by the second fine-periodic pattern 138 and the diffraction pattern induced by the second coarse periodic pattern 146 sum to form a single wavefront of diffracted image-bearing light that exists the second image light guide 106 in the first direction DR1 toward the eyebox E.

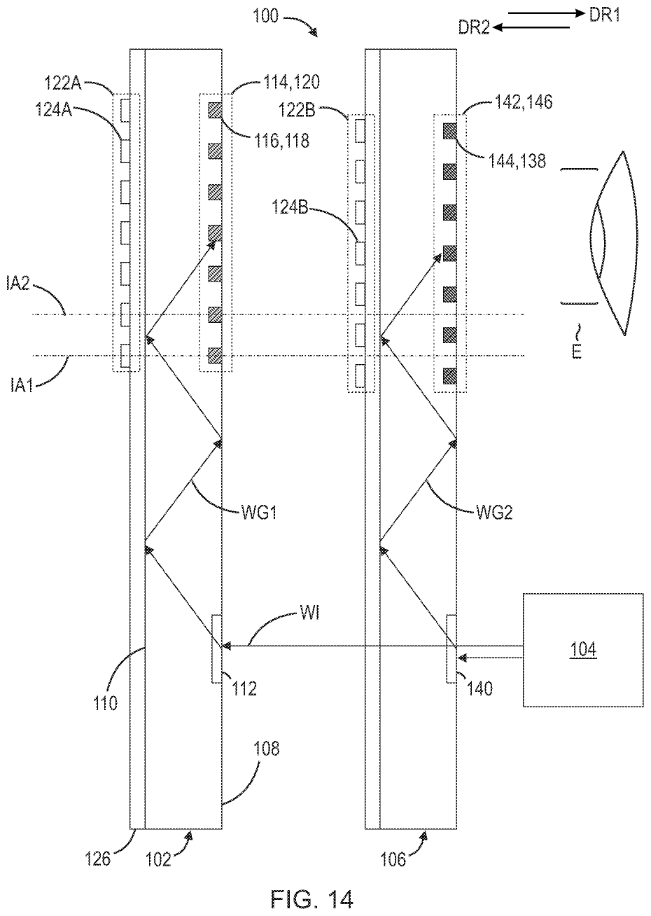

FIG. 14 illustrates another exemplary configuration of image light guide system 100 where the image light guide system 100 includes more than one image-light guide, e.g., a first image light guide 102 and a second image light guide 106, forming an image light guide stack. However, in FIG. 14, the first image light guide 102 includes a first blocking region 122A and second image light guide 106 includes a second blocking region 122B. In this example, the first fine periodic pattern 118 of the sub-regions 116 of the first image light guide 102 are optimized to diffract at least a portion of light WG1 that is within a first wavelength range, e.g., blue or green light. Additionally, the second fine periodic pattern 138 of the sub-regions 144 of the second image light guide 106 are optimized to diffract at least a portion of light WG2 that is within a second wavelength range different than the first, e.g., red light. In this example, each blocking region 122A, 122B comprises a dichroic filter material optimized to reflect light from within the first and second wavelength ranges, respectively. For example, first reflected portion WR1 generated by image-bearing light WG1 interacting with sub-regions 116 are of the first wavelength range, e.g., blue or green light. The blocking features 124A of blocking region 122A are dichroic filters optimized to block transmission of light within the first wavelength range, e.g., blue or green light, but allow all other wavelengths to transmit with high efficiency. Similarly, second reflected portion WR2 generated by image-bearing light WG2 interacting with sub-regions 144 are of the second wavelength range, e.g., red light. The blocking features 124B of blocking region 122B are dichroic filters optimized to block transmission of light within the second wavelength range, e.g., red light, but allow all other wavelengths to transmit with high efficiency. As shown in FIG. 14, the positions of each of the sub-regions 144 of the second image light guide 106 are offset or shifted (within a plane parallel with second planar surface 110) with respect to the positions of the sub-regions 116 of the first image light guide 102, such that the respective blocking features 124A do not share a common axis. e.g., imaginary axis IA1 or IA2, with any of the sub regions 144 or any of the blocking features 124B.

In other examples of the image light guide system 100 shown in FIG. 14, each of the sub-regions 144 are aligned with, i.e., share a common imaginary axis (e.g., IA1 and/or IA2) with, respective blocking features 124A of blocking region 122A of first image light guide 102. Additionally, each sub-region 116 is aligned with a respective blocking feature 124B of blocking regions 122B of second image light guide 106.

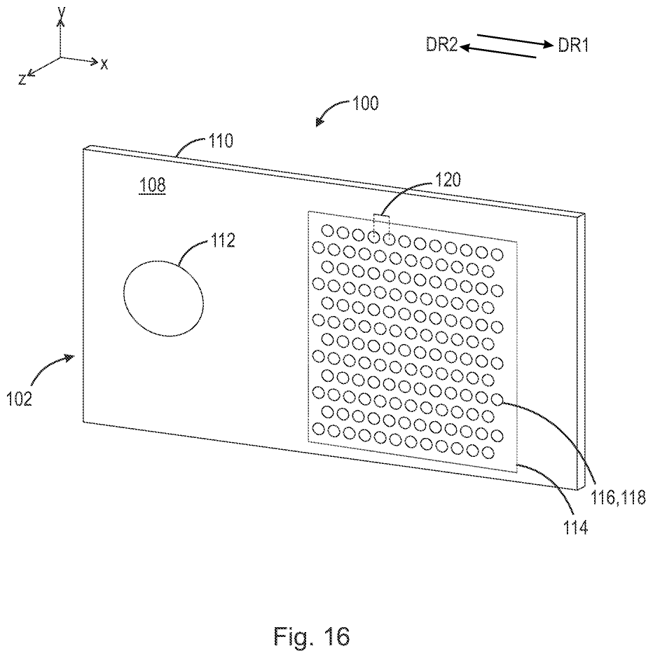

FIG. 16 illustrates is a front perspective view of an image light guide 102 according to an exemplary embodiment. In this example embodiment, image light guide 102 has no blocking region 122 or blocking features 124. Instead, image light guide 102 includes a first out-coupling diffractive region 114 having a first plurality of out-coupling diffractive sub-regions 116 which can take the form of any of the exemplary configurations described above with respect to FIG. 3. In this example configuration, sub-regions 116 may also be referred to here as “sparse gratings” or “sparse grating patterns” in that they comprise a plurality of individual grating areas, i.e., each sub-region 116. In some examples, sub-regions 116 are all identical to each other across all known parameters. For example, each sub-region can have the same shape, size, area, and include a fine periodic pattern 118 of diffractive features, e.g., linear surface relief gratings, having a common pitch and a common grating vector. Additionally, the sub-regions 116 can form a coarse periodic pattern 120 defining the spacing between each sub-region 116 within diffractive out-coupling region 114. The coarse periodic pattern 120 can represent a uniform spacing between each sub-region 116, or a non-uniform spacing between each sub-region 116. It should be appreciated that the coarse periodic pattern 120 is chosen such that a plurality of sub-regions 116 are present within an area of the out-coupling diffractive region 114 that roughly approximates or is equal to the pupil area of the human eye. In other words, multiple sub-regions 116 will fit within an eyebox and output light for viewing within the user's/wearer's pupil.

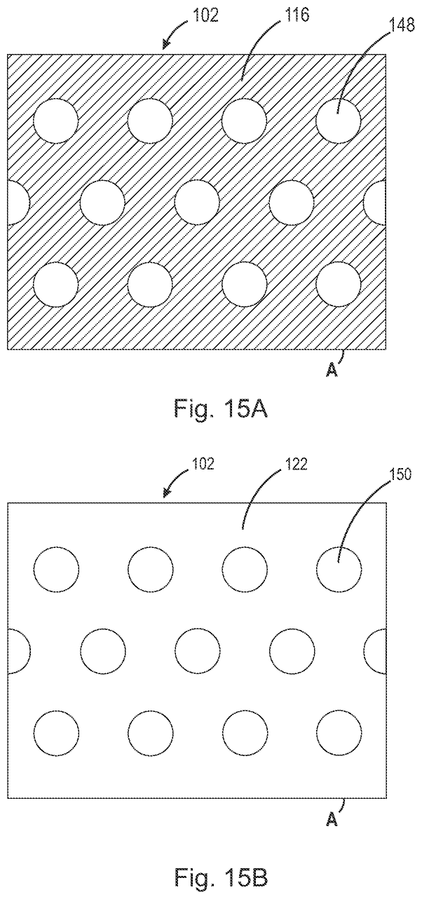

It should be understood that although the foregoing exemplary embodiments illustrate configurations that utilize a plurality of diffractive sub-regions 116,144, that each include a plurality of diffractive features while the area between each sub-region does not include diffractive features, that this arrangement can be reversed or inverted. For example, as shown in FIG. 15A, which illustrates a front view of an alternative configuration of section A in FIG. 3, rather than diffractive region 114 including a plurality of diffractive sub-regions 116, it may include a single diffractive region 116, and a plurality of open sub-regions 148. As illustrated, sub-region 116 includes a plurality of diffractive features, e.g., linear gratings, while open sub-regions 148 do not include any diffractive features and are arranged to allow environmental light to pass through the image light guide and enter the user's eyes. Similarly, FIG. 15B, which illustrates a rear view of an alternative configuration of section A in FIG. 3, rather than blocking region 122 including a plurality of blocking features 124, it may include a single blocking region 122, and a second plurality of open sub-regions 150. The single blocking region 122 can comprise an absorptive or reflective material as described above, and is arranged to block forward light diffracted in the second direction DR2 (shown in FIG. 4) from leaving the image light guide system 100, while second plurality of open sub-regions 150 do not include any absorptive or reflective material features and are arranged to allow environmental light to pass through the image light guide and enter the user's eyes. Similar to the arrangements above the first plurality of open sub-regions 148 and the second plurality of open sub-regions 150 are coaxial, i.e., each open sub-region 148 shares a common imaginary axis with a respective sub-region 150, where the imaginary axes are arranged to pass through a plane that is substantially parallel with the one or more surfaces of the image light guide 102. In some examples, the respective area of each open-sub-region 150 may be less than the respective area of each open-sub-region 148 to account for angular dispersion through the thickness of the image light guide 102 relative to the desired FOV of the image light guide system 100. It should be appreciated that, the total area of the blocking region 122 can be equal to or less than 50% of the collective areas of the second plurality of open sub-regions 150.

One or more features of the embodiments described herein may be combined to create additional embodiments which are not depicted. While various embodiments have been described in detail above, it should be understood that they have been presented by way of example, and not limitation. It will be apparent to persons skilled in the relevant arts that the disclosed subject matter may be embodied in other specific forms, variations, and modifications without departing from the scope, spirit, or essential characteristics thereof. The embodiments described above are therefore to be considered in all respects as illustrative, and not restrictive. The scope of the invention is indicated by the appended claims, and all changes that come within the meaning and range of equivalents thereof are intended to be embraced therein.

What is claimed is:

1. An image light guide system, comprising:
an image light guide comprising:
an in-coupling diffractive optic operable to couple image-bearing light into the image light guide; and
an out-coupling diffractive region comprising a plurality of sub-regions, wherein each sub-region comprises a plurality of diffractive features arranged to out-couple at least a first portion of the image-bearing light and direct the first portion of image-bearing light in a first direction toward an eyebox, and wherein the plurality of diffractive features are arranged to diffract at least a second portion of the image-bearing light in a second direction opposite the first direction; and
a blocking region comprising a plurality of blocking features, wherein each blocking feature of the plurality of blocking features is aligned with a respective sub-region of the out-coupling diffractive region, such that each blocking feature of the plurality of blocking features is operable to prevent the second portion of the image-bearing light from exiting the image light guide system in the second direction.

2. The image light guide system of claim 1, wherein each of the plurality of blocking features comprise an absorptive material or a reflective material.

3. The image light guide system of claim 1, wherein the image light guide further comprises a first planar surface and a second planar surface opposite the first planar surface, and wherein the out-coupling diffractive region is arranged on, in, or engaged with the first planar surface, and the blocking region is arranged on, in, or engaged with the second planar surface.

4. The image light guide system of claim 1, wherein the image light guide further comprises a first planar surface and a second planar surface opposite the first planar surface, wherein each blocking feature of the plurality of blocking features is aligned with a respective sub-region along a respective imaginary axis of a plurality of imaginary axes, and wherein each respective imaginary axis is arranged to pass through a respective sub-region, a respective blocking feature, the first planar surface, and the second planar surface.

5. The image light guide system of claim 1, further comprising a cladding layer engaged with the image light guide, wherein the plurality of blocking features are arranged on, in, or engaged with the cladding layer.

6. The image light guide system of claim 5, wherein the image light guide further comprises a first planar surface and a second planar surface opposite the first planar surface, and wherein the out-coupling diffractive region is arranged on, in, or engaged with the second planar surface.

7. The image light guide system of claim 1, wherein the image light guide further comprises a first planar surface and a second planar surface opposite the first planar surface, the image light guide system further comprising a support substrate positioned a first distance from the second planar surface of the image light guide defining an air gap between the support substrate and the image light guide, wherein the blocking region is located on, in, or engaged with the support substrate.

8. The image light guide system of claim 7, wherein:
the blocking region is a first blocking region and wherein the plurality of blocking features are a first plurality of blocking features:
the support substrate comprises a third planar surface and a fourth planar surface opposite the third planar surface; and
the image light guide system further comprises a second blocking region, wherein the first blocking region is located on, in, or engaged with the third planar surface of the support substrate and the second blocking region is located on, in, or engaged with the fourth planar surface of the support substrate.

9. The image light guide system of claim 8, wherein the first blocking region comprises the first plurality of blocking features and the second blocking region comprises a second plurality of blocking features, wherein each blocking feature of the first plurality of blocking features comprise a reflective material and each blocking feature of the second plurality of blocking features comprise an absorptive material.

10. The image light guide system of claim 1, wherein an area of each respective blocking feature is larger than an area of each respective sub-region of the out-coupling diffractive region.

11. The image light guide system of claim 1, wherein each sub-region of the out-coupling diffractive region and each blocking feature of the plurality of blocking features are circular, and wherein a diameter of each sub-region is less than a diameter of each respective blocking feature.

12. The image light guide system of claim 1, wherein each sub-region of the out-coupling diffractive region and each blocking feature of the plurality of blocking features are linear or rectangular.

13. The image light guide system of claim 1, wherein the diffractive features within at least one sub-region of the out-coupling diffractive region form a first fine periodic pattern and the plurality of sub-regions of the out-coupling diffractive region form a first coarse periodic pattern defined by a spacing between each sub-region, wherein the first fine periodic pattern is configured to diffract the first and second portions of image-bearing light and the first coarse periodic pattern is configured to diffract at least a third portion of image-bearing light in the first direction.

14. The image light guide system of claim 13, wherein the diffractive features within a first sub-region of the out-coupling diffractive region form the first fine periodic pattern, and the diffractive features within a second sub-region of the out-coupling diffractive region form a second fine periodic pattern, wherein the first fine periodic pattern is optimized to diffract image-bearing light of a first wavelength range and the second fine periodic pattern is optimized to diffract image-bearing light of a second wavelength range different than the first wavelength range.

15. The image light guide system of claim 1, further comprising an image source system, the image source system operable to generate the image-bearing light.

16. The image light guide system of claim 1, wherein the image light guide is a first image light guide, the in-coupling diffractive optic is a first in-coupling diffractive optic, the out-coupling diffractive region is a first out-coupling diffractive region, and the plurality of sub-regions are a first plurality of sub-regions, the image light guide system further comprising:
a second image light guide comprising:
a second in-coupling diffractive optic operable to couple the image-bearing light into the second image light guide; and
a second out-coupling diffractive region comprising a second plurality of sub-regions, wherein each sub-region of the second plurality of out-coupling diffractive sub-regions comprises a plurality of diffractive features arranged to out-couple at least a fourth portion of the image-bearing light and direct the fourth portion of the image-bearing light in the first direction toward the eyebox, and wherein the plurality of diffractive features are arranged to diffract at least a fifth portion of the image-bearing light in the second direction opposite the first direction.

17. The image light guide system of claim 16, wherein the diffractive features of at least one sub-region of the first plurality of sub-regions is optimized to diffract image-bearing light of a first wavelength range, and wherein the diffractive features of at least one sub-region of the second plurality of sub-regions is optimized to diffract image-bearing light of a second wavelength range different than the first wavelength range.

18. The image light guide system of claim 1, further comprising a polarizer arranged optically before the in-coupling diffractive optic, wherein the polarizer is configured to polarize the image-bearing light in a first orientation, and the plurality of blocking features comprise linearly polarizing features of a second orientation rotated ninety-degrees relative to the first orientation.

19. An image light guide system, comprising:
an image light guide comprising:
an in-coupling diffractive optic operable to couple image-bearing light into the image light guide; and
an out-coupling diffractive region comprising a plurality of diffractive features arranged to out-couple at least a first portion of the image-bearing light and direct the first portion of image-bearing light in a first direction toward an eyebox, and wherein the plurality of diffractive features are arranged to diffract at least a second portion of the image-bearing light in a second direction opposite the first direction;
a first plurality of open sub-regions arranged within the out-coupling diffractive region; and,
a blocking region comprising a second plurality of open sub-regions, wherein each open sub-region of the first plurality of open sub-regions is aligned with a respective open sub-region of the second plurality of open sub-regions, such that the blocking region is operable to prevent the second portion of the image-bearing light from exiting the image light guide system in the second direction.

20. The image light guide system of claim 19, further comprising a cladding layer engaged with the image light guide and wherein the blocking region and the second plurality of open sub-regions are arranged on, in, or engaged with the cladding layer.

21. An image light guide, comprising:
an in-coupling diffractive optic operable to couple image-bearing light into the image light guide; and
an out-coupling diffractive region comprising a plurality of sub-regions, wherein each sub-region comprises a plurality of diffractive features arranged to out-couple at least a first portion of the image-bearing light and direct the first portion of image-bearing light in a first direction toward an eyebox.
